(19) United States
(12) Patent Application Publication
(10) Pub. No.: US 2024/0064842 A1
(43) Pub. Date: Feb. 22, 2024

(54) BEAM MANAGEMENT FOR SMALL DATA TRANSMISSION AND RECEPTION

(71) Applicant: GOOGLE LLC, Mountain View, CA (US)

(72) Inventor: Shiangrung Ye, Sanchong District, New Taipei City (TW)

(21) Appl. No.: 18/270,474

(22) PCT Filed: Dec. 10, 2021
(86) PCT No.: PCT/US2021/062823

§ 371 Date: Jun. 29, 2023

Related U.S. Application Data
(60) Provisional application No. 63/131,630, filed on Dec. 29, 2020.

(51) Int. Cl. H04W 76/19; H04W 72/12; H04W 72/232; H04W 74/08

(52) U.S. Cl. CPC H04W 76/19; H04W 72/12; H04W 72/232; H04W 74/0833

(57) ABSTRACT

A method in a user equipment (UE) for beam management includes detecting (802), when the UE is in an inactive state associated with a protocol for controlling radio resources, a trigger event related to communicating data between the UE and a base station in the inactive state of the UE. The method also includes starting (804) a timer in response to detecting the trigger event. Further, the method includes monitoring (806), only while the timer is running, a beam for beam failure, the beam for communicating the UE and the base station.

### FIELD OF THE DISCLOSURE

This disclosure relates to wireless communications and, more particularly, to techniques for beam management and small data transmission (SDT).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) radio interface (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

The UE in some scenarios can concurrently utilize resources of multiple nodes (e.g., base stations or components of a distributed base station) of a radio access network (RAN), interconnected by a backhaul. In these scenarios, the UE is considered to be operating in multi-connectivity (MC) with the multiple nodes. For example, when the UE concurrently utilizes resources of two network nodes, the UE is considered to be operating in dual connectivity with the two network nodes. When these network nodes support different radio access technologies (RATs), such as 5G NR and EUTRA, this type of connectivity is referred to as Multi-Radio Dual Connectivity (MR-DC). When a UE operates in MR-DC, one base station operates as the MN that covers a primary cell (PCell), and the other base station operates as the SN that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station), interconnected to other network elements by a backhaul.

The MN can provide a control-plane connection and a user-plane connection to a core network (CN), whereas the SN generally provides a user-plane connection. A base station (e.g., MN, SN) and/or the CN in some cases causes the UE to transition from one state of the RRC protocol to another state. More particularly, the UE can operate in an idle state (e.g., EUTRA-RRC_IDLE, NR-RRC IDLE), in which the UE does not have a radio connection with a base station; a connected state (e.g., EUTRA-RRC_CONNECTED, NR-RRC CONNECTED), in which the UE has a radio connection with the base station; or an inactive state (e.g., EUTRA-RRC INACTIVE, NR-RRC INACTIVE), in which the UE has a suspended radio connection with the base station.

By operating in the inactive state, the UE can save power in comparison to the connected state. Because the UE suspends the radio connection instead of releasing the radio connection, the UE can quickly resume the radio connection to communicate with a base station. Further, certain recently introduced techniques such as early data transmission and small data transmission (SDT) allow the UE to transmit data while operating in the inactive state. Both configured grant (CG)-based SDT and random access (RA)-based SDT schemes generally allow the UE to communicate with the base station during the inactive state.

To support data transmission and reception in the inactive state, the UE should support beam failure detection and beam failure recovery procedures. However, existing beam failure detection and recovery procedures are configured for UEs operating in the connected state, and thus are not designed for the power-saving aspects of the inactive state. It is therefore not clear how the UE is to perform beam failure detection and recovery during the inactive state.

### SUMMARY

A UE and/or a base station can implement the beam management techniques of this disclosure. In particular, a UE in an inactive state can save power by only performing beam failure detection during a time window. Accordingly, when the UE is in the inactive state, the UE can detect a trigger event related to communicating data between the UE and a base station while maintaining the inactive state of the UE. The UE can then start a timer in response to detecting the trigger event. To save power, the UE can monitor for a failure of a beam for communicating the data only while the timer is running. Thus, if the timer expires, or if the UE receives a command from the base station to stop the timer, the UE stops performing beam failure detection.

In some implementations, the trigger event includes transmitting uplink data to the base station in accordance with a configured grant (CG) and/or receiving downlink data from the base station in accordance with a downlink assignment. In other implementations, the trigger event includes receiving a downlink control information (DCI) from the base station that includes an uplink grant or downlink assignment. In another implementations, the trigger event includes receiving downlink data that contains a UE Contention Resolution Identity medium access control (MAC) control element (CE).

To monitor for the beam failure during the time window, the UE can determine whether the signal strength of the beam is below a signal strength threshold. In some implementations, the UE detects a beam failure if the signal strength of the beam stays below the signal strength threshold for a predetermined time. In other implementations, the UE detects a beam failure if a number of instances of beam failure detected at a layer below a MAC layer exceeds a predetermined number during a time window.

In response to detecting a beam failure during the time window, the UE can perform a beam failure recovery procedure. To perform the beam failure recovery procedure, the UE can select a new beam based on signal strength measurements. The UE can then utilize a random access (RA)-based or a CG-based approach for beam failure recovery.

In some implementations, the UE can perform a contention-free RA procedure, a four-step contention-based RA procedure, or a two-step contention-based RA procedure. In the case of the contention-free RA procedure, the UE may transmit, to the base station, a dedicated RA preamble that is associated both with the new beam and with the inactive state failure recovery procedure. Accordingly, based on the dedicated RA preamble, the base station can identify that the UE initiated the RA procedure in order to perform beam failure recovery while in an inactive state. In the case of the four-step or two-step contention-based RA procedures, the UE can transmit to the base station a preamble associated with the new beam and a payload transmission, where the payload transmission can indicate that the UE initiated the RA procedure in order to perform beam failure recovery while in an inactive state. The payload transmission may also indicate a candidate beam with a signal strength measurement above a signal strength threshold.

In other implementations, the UE can identify a CG associated with the new beam, and transmit a message to the base station in accordance with the CG. Similar to the payload transmission of the contention-based RA procedures, the message can indicate that UE detected a beam failure and/or include an indication of a candidate beam.

Further, to communicate with the UE while the UE is in the inactive state, the base station may assign a temporary identifier to the UE to utilize while the UE is in the inactive state. As one example, the base station can use the temporary identifier to transmit dedicated RA preambles for contention-free RA procedures to the UE. The UE can then utilize these dedicated RA preambles to perform beam failure recovery while in an inactive state, as discussed above. As another example, the base station can use the temporary identifier to transmit a DCI to the UE at a paging occasion for the UE. The UE can identify that the DCI is addressed to the UE based on the temporary identifier.

One example embodiment of these techniques is a method implemented in a UE for beam management. The method can be executed by processing hardware and includes detecting, when the UE is in an inactive state associated with a protocol for controlling radio resources, a trigger event related to communicating data between the UE and a base station in the inactive state of the UE. The method also includes starting a timer in response to detecting the trigger event. Further, the method includes monitoring, only while the timer is running, a beam for beam failure, the beam for communicating the UE and the base station.

Another example embodiment of these techniques is a UE including processing hardware and configured to implement the method above.

A further example embodiment of these techniques is a method implemented in a base station for beam management. The method can be executed by processing hardware and includes receiving, from a UE, a random access preamble during a random access procedure. The method also includes determining, based on the random access preamble, that the UE is performing a beam recovery procedure in an inactive state associated with a protocol for controlling radio resources.

Another example embodiment of these techniques is a method implemented in a base station for communicating with a UE. The method can be executed by processing hardware and includes transmitting, to the UE, a temporary identifier for the UE to utilize when operating in an inactive state associated with a protocol for controlling radio resources. The method also includes applying the temporary identifier to a downlink control information for the UE. The method further includes transmitting the downlink control information to the UE when the UE operates in the inactive state.

Yet another example embodiment of these techniques is a base station including processing hardware and configured to implement the methods above.

### BRIEF DESCRIPTION OF THE DRAWINGS

FIG. 1 is a block diagram of an example system in which a base station of a radio access network (RAN) and a user equipment (UE) can implement the techniques of this disclosure for communicating while the UE is operating in an inactive state;

FIG. 2 is a block diagram of an example protocol stack according to which the UE of FIG. 1 communicates with base stations;

FIG. 3A is a messaging diagram of an example scenario in which a UE operating in an inactive state starts a timer in which to perform beam failure detection in response to transmitting data in accordance with a configured grant;

FIG. 3B is a messaging diagram of an example scenario similar to the scenario of FIG. 3A, but where the UE starts the timer in response to receiving data in accordance with a downlink assignment;

FIG. 3C is a messaging diagram of an example scenario similar to the scenario of FIG. 3A, but where the UE starts the timer in response to receiving a downlink control information (DCI);

FIG. 3D is a messaging diagram of an example scenario similar to the scenario of FIG. 3B, but where the UE starts the timer in response to receiving downlink data that contains a UE Contention Resolution Identity MAC CE;

FIG. 4A is a messaging diagram of an example scenario in which a UE performs a contention-free random access procedure to perform beam failure recovery;

FIG. 4B is a messaging diagram of an example scenario similar to the scenario of FIG. 4A, but where the UE receives a DCI in response to transmitting a dedicated random access preamble during the contention-free random access procedure;

FIG. 4C is a messaging diagram of an example scenario similar to the scenario of FIG. 4A, but where the UE uses a four-step contention-based random access procedure to perform beam failure recovery;

FIG. 4D is a messaging diagram of an example scenario similar to the scenario of FIG. 4A, but where the UE uses a two-step contention-based random access procedure to perform beam failure recovery;

FIG. 4E is a messaging diagram of an example scenario in which a UE transmits a message to a base station using a configured grant to perform beam failure recovery;

FIG. 5 is a flow diagram of an example method for determining to switch from an RA-based SDT to a CG-based SDT when operating in the inactive state, which can be implemented in a UE of this disclosure;

FIG. 6 is a flow diagram of an example method for transmitting a candidate beam report to a base station when operating in the inactive state, which can be implemented in a UE of this disclosure;

FIG. 7 is a flow diagram of an example method for transmitting a DCI to a UE using a radio network temporary identifier (RNTI) of a UE operating in the inactive state, which can be implemented in a base station of this disclosure;

FIG. 8 is a flow diagram of an example beam management method, which can be implemented by a UE of this disclosure;

FIG. 9 is a flow diagram of an example beam management method, which can be implemented by a base station of this disclosure; and

FIG. 10 is a flow diagram of an example method for communicating with a UE, which can be implemented by a base station of this disclosure.

### DETAILED DESCRIPTION OF THE DRAWINGS

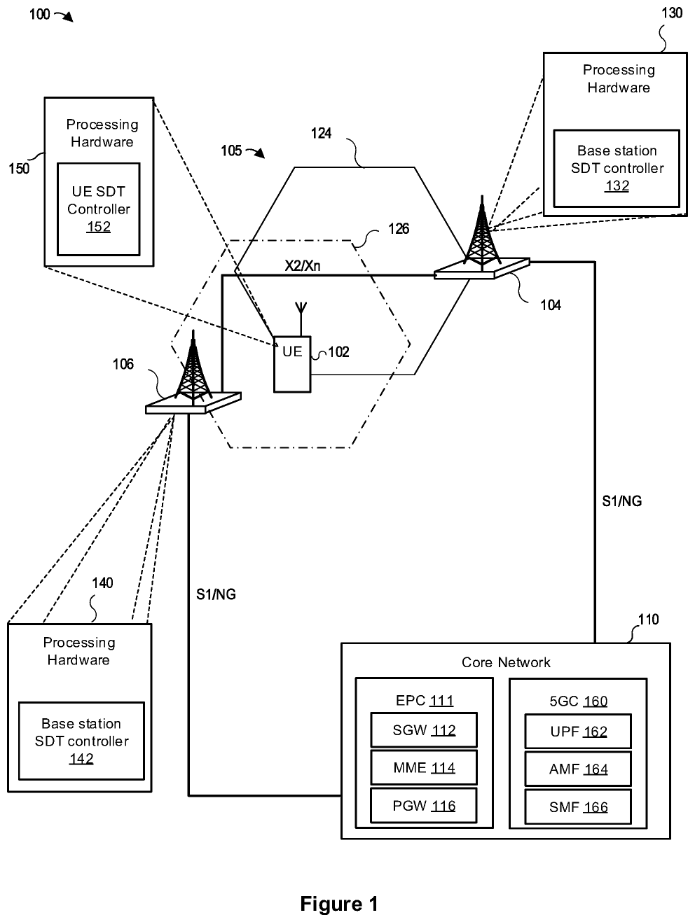

FIG. 1 depicts an example wireless communication system 100 that can implement the techniques of this disclosure. The wireless communication system 100 includes a UE 102, a base station 104, a base station 106, and a core network (CN) 110. The techniques of this disclosure can be implemented in the UE 102 or in one or both of the base stations 104 and 106.

The base stations 104 and 106 can be any suitable type, or types, of base stations, such as an evolved node B (eNB), a next-generation eNB (ng-eNB), or a 5G Node B (gNB), for example. The UE 102 can communication with the base station 104 and the base station 106 via the same radio access technology (RAT), such as EUTRA or NR, or different RATs. The base station 104 supports a cell 124, the base station 106 supports a cell 126. The cell 124 partially overlaps with the cell 126, such that the UE 102 can be in range to communicate with base station 104 while simultaneously being in range to communicate with the base station 106 (or in range to detect or measure the signal from the base station 106). The overlap can make it possible for the UE 102 to hand over between cells (e.g., from the cell 124 to the cell 126) or base stations (e.g., from the base station 104 to the base station 106). As another example, the UE 102 can communicate in dual connectivity (DC) with the base station 104 (operating as an MN) and the base station 106 (operating as an SN).

The base stations 104 and 106 operate in a radio access network (RAN) 105 connected to the CN 110, which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a gNB that supports the NR radio interface as well as an NG interface for communicating with the 5GC 160. The base station 106 can be implemented as an eNB with an S1 interface to the EPC 111, an ng-eNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104 and 106 can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

With continued reference to FIG. 1, the base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1 includes a base station SDT controller 132 that is configured to support the techniques of this disclosure, discussed below. Similarly, the base station 106 is equipped with processing hardware 140 and a base station SDT controller 142, which are similar to the processing hardware 130 and the SDT controller 132, respectively.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1 includes a UE SDT controller 152 that is configured to support the techniques of this disclosure, discussed below.

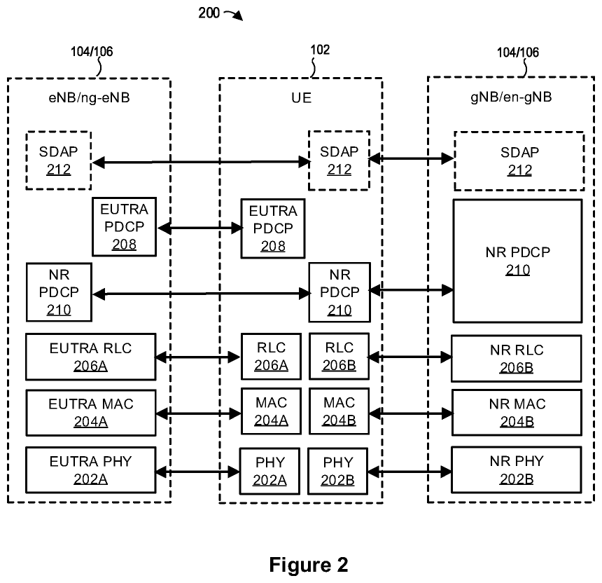

Next, FIG. 2 illustrates, in a simplified manner, an example protocol stack 200 according to which the UE 102 can communicate with an eNB/ng-eNB or a gNB (e.g., one or both of the base stations 104 and 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

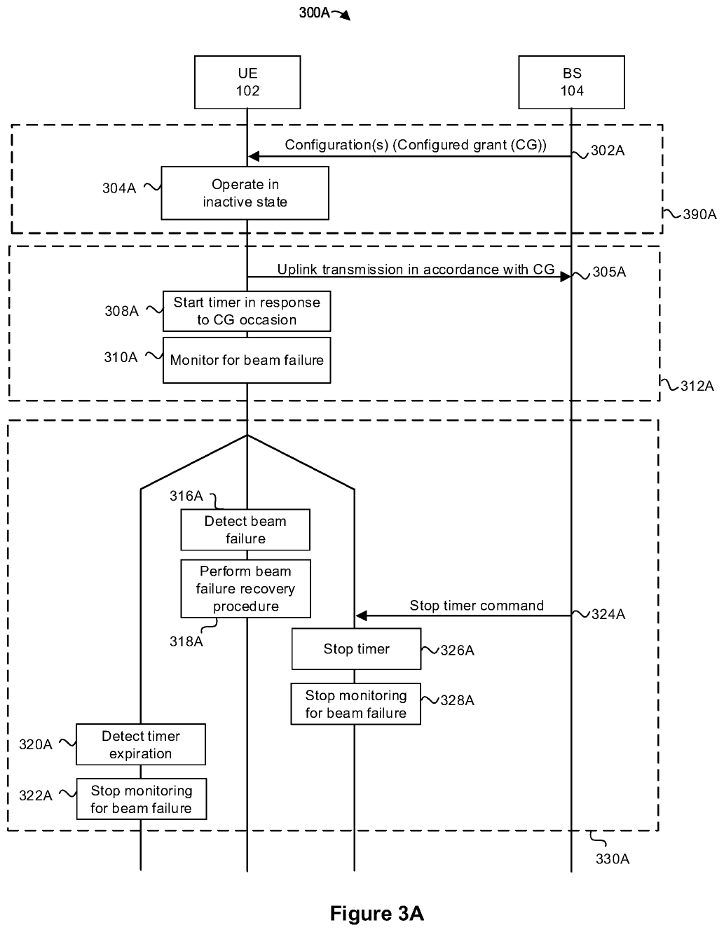

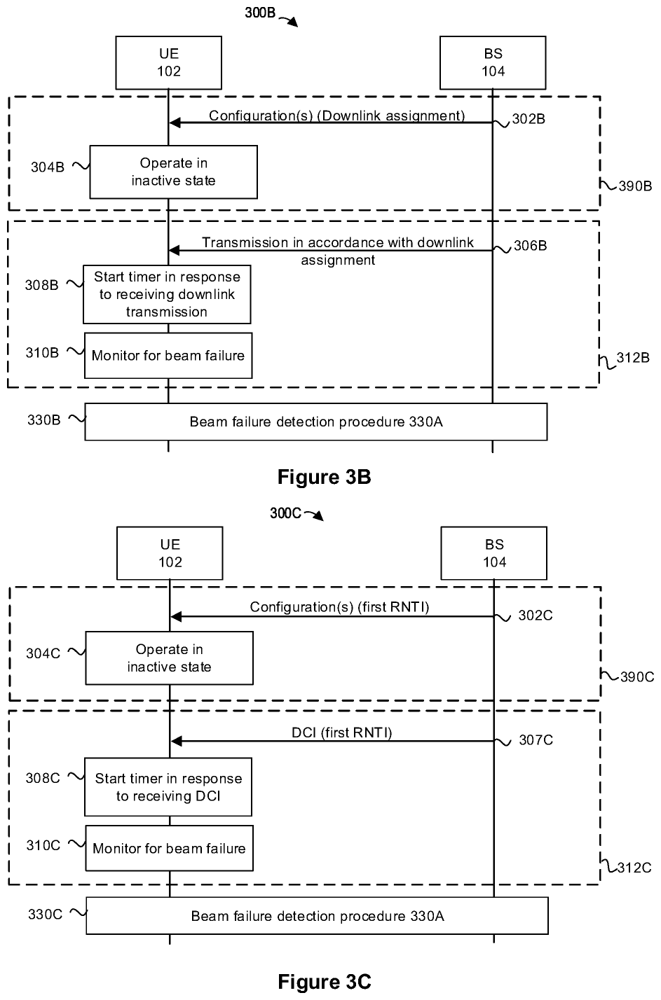

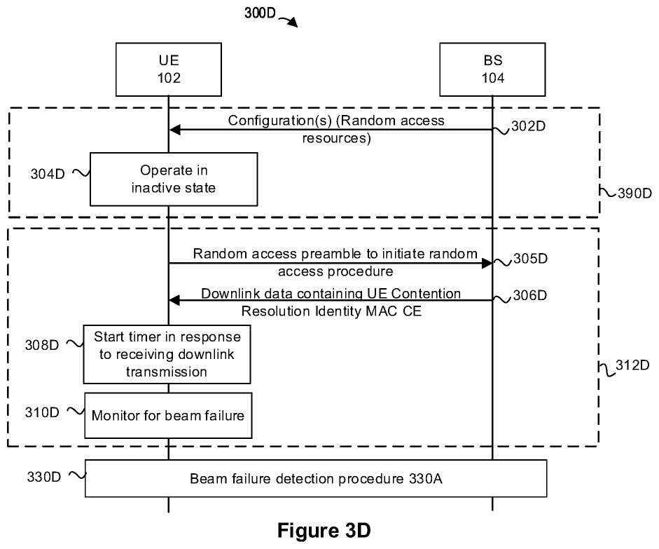

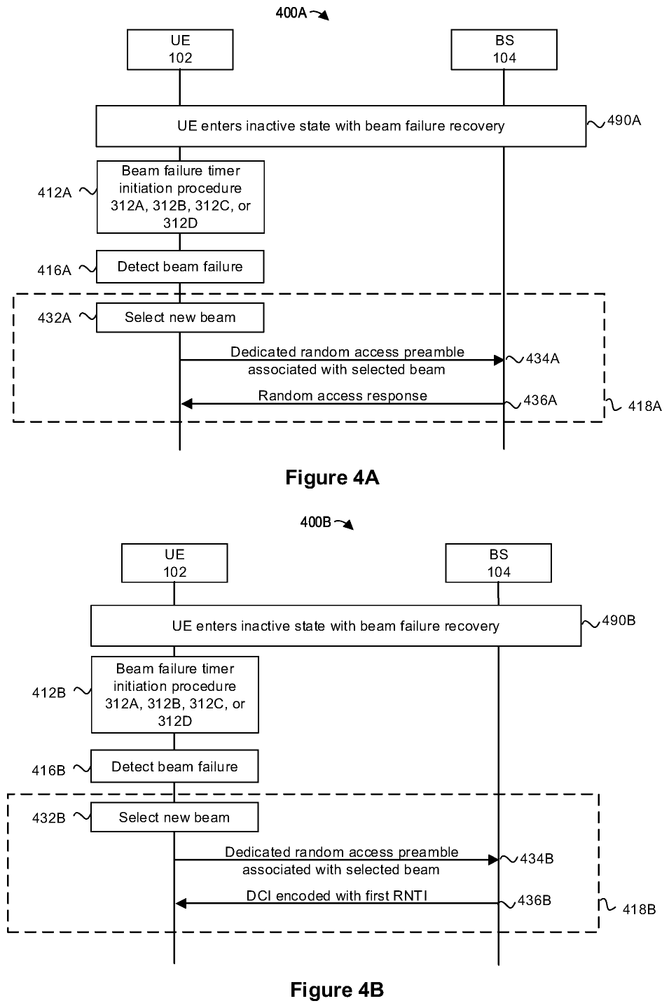

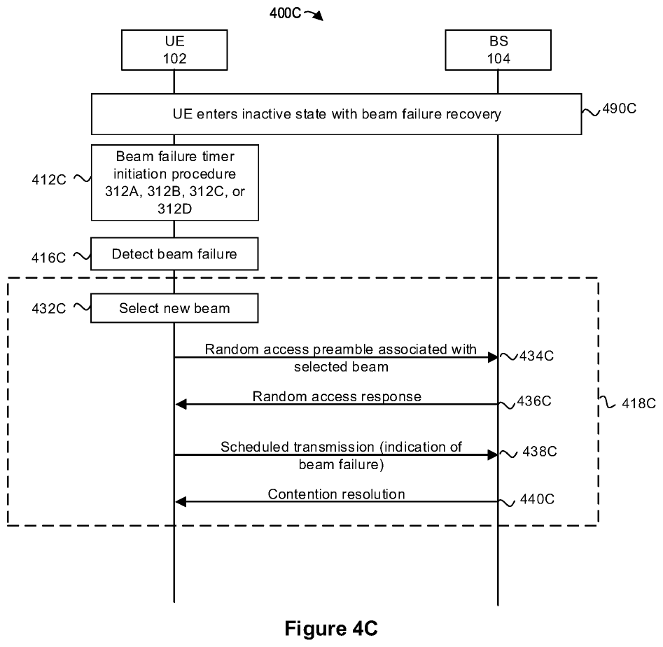

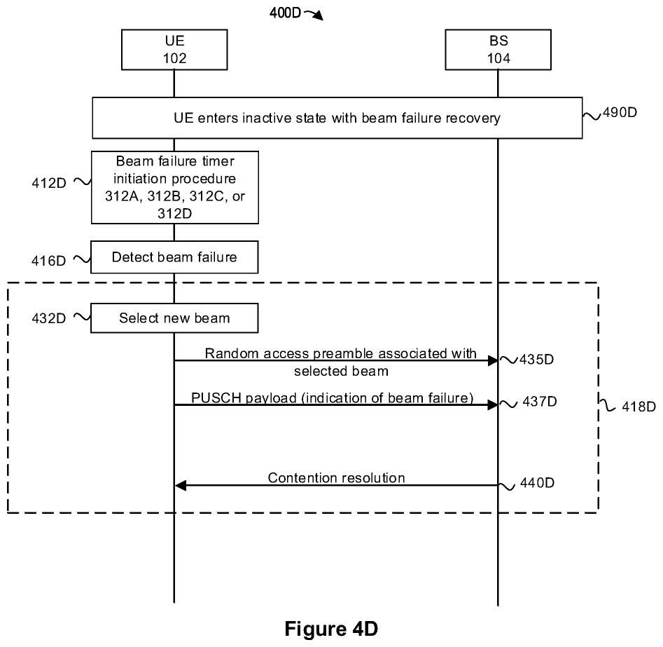

FIGS. 3A-4E are messaging diagrams of example scenarios in which a base station and UE implement the techniques of this disclosure for beam management and SDT. Generally speaking, events in FIGS. 3A-4E that are similar are labeled with similar reference numbers (e.g., event 316A is similar to events 316B, 316C, 416A, 416B, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

As an initial note, a UE communicating data with a base station when operating in an inactive state can also be referred to as UE performing SDT. In order to perform SDT, the size of the data may need to be below a threshold size.

Referring first to FIG. 3A, a base station 104 communicates with a UE 102 during a scenario 300A. The UE 102 can have a receiving beam and a transmitting beam for communicating with the base station in the downstream (downlink) and upstream (uplink) directions, respectively. After the UE 102 and the base station 104 determine their positioning relative to each other, these beams can substantially coincide in direction per beam reciprocity principles. Accordingly, in this disclosure, a downlink beam and an uplink beam can be collectively referred to as a beam for communicating with a base station. Further, while the examples of this disclosure describe beams that carry data payloads, a beam can carry a Synchronization Signal Block (SSB) or can correspond to a Channel Status Information-Reference Signal (CSI-RS). For example, to select a beam for communicating data, the UE may perform signal strength and/or signal quality measurements using a CSI-RS or SSB corresponding to the beam.

Initially, the base station 104 transmits 302A a configuration message including one or more configurations. The information included in the configuration message can vary depending on implementation. In the scenario 300A, the configuration message includes at least one or more configured grants (CGs). A CG includes a radio resource configuration for a scheduled uplink transmission (e.g., time and/or frequency resources, periodicity, etc.). Each CG is also associated with a beam. For example, a first CG is associated with a first beam, and a second CG is associated with a second beam. While operating in an inactive state, the UE 102 can transmit uplink data in accordance with a CG.

In some implementations, the configuration message includes a downlink control information (DCI). The DCI may include an indication of a beam, and may command the UE 102 to switch from a current beam to the indicated beam in order to receive downlink transmissions. The DCI may also include random access preambles for the UE 102 to utilize when operating in the inactive state, which will be discussed with reference to FIGS. 4A-4D.

Further, in some implementations, the first transmission includes a fixed frame configuration. The fixed frame configuration may indicate a periodicity and channel occupancy time (COT) for fixed frame periods (FFPs).

The configuration message that the base station 104 transmits 302A may be a Radio Resource Control (RRC) message that causes the UE 102 to transition to an inactive state (e.g., RRC_INACTIVE), such as an RRC Release message or an RRC Reject message.

Accordingly, after or in response to the configuration message, the UE 102 begins 304A to operate in an inactive state. The events 302A and 304A are collectively referred to in this disclosure as an inactive state initiation procedure 390A. During the inactive state initiation procedure 390A, the UE 102 receives 302A configuration information for the UE 102 to utilize while operating in the inactive state, and the UE 102 enters 304A the inactive state. Further, as will be discussed, the UE 102 enters the inactive state configured to perform beam failure recovery (e.g., using the configuration information that the UE 102 receives 302A).

Next, the UE 102 starts a timer in response to detecting a trigger event while the UE 102 operates in the inactive state. This timer is sometimes referred to in this disclosure as a “beam failure timer.” In the scenario 300A, the UE 102 transmits 305A uplink data to the base station 104 in accordance with a CG resource included in the configuration message. Upon or after this CG occasion, the UE 102 starts 308A a timer. The length of the time window over which the timer runs may be preconfigured at the UE 102, and/or the base station 104 or another base station of the RAN 105 may transmit an indication of the time window length to the UE 102. During the time window while the timer is running, and only while the timer is running, the UE 102 monitors 310A for beam failure of a beam for communicating data with the base station 104. If the UE 102 transmits uplink data in accordance with a second CG while the timer is running, the UE 102 can restart the timer, and continue to monitor for beam failure while the timer is running.

The UE 102 can monitor for beam failure using one or more beam detection methods. For example, the UE 102 can perform signal strength measurements (e.g., Reference Signal Received Power (RSRP) measurements) on the beam. Additionally or alternatively, the UE 102 can perform signal quality measurements (e.g., Reference Signal Received Quality (RSRQ) measurements) on the beam. The UE 102 can detect a beam failure in response to the signal strength measurements and/or signal quality measurements (referred to in this disclosure as “signal measurements” for brevity) being below a signal strength threshold and/or signal quality threshold, respectively. The signal strength or signal quality thresholds may be preconfigured at the UE 102, or configured at the UE 102 by the base station 104. In some implementations, the UE 102 can detect a beam failure in response to the signal strength measurements and/or signal quality measurements staying below the signal strength threshold and/or signal quality threshold, respectively, for a predetermined period of time.

In other implementations, the UE 102 can detect a beam failure in response to determining that a number of beam failure instances, detected at a layer below a medium access control (MAC) layer (e.g., below the MAC layer 204A), exceeds a predetermined number while the timer is running. For example, if the number of beam failure instances detected at the PHY layer 202A and passed from the PHY layer 202A to the MAC layer 204A exceeds the predetermined number during the time window of the timer, then the UE 102 can detect a beam failure. Additionally or alternatively, the number of beam failure instances can be counted cumulatively over multiple time windows of the timer. If the number of detected beam failure instances on the cumulative counter exceeds the predetermined number, then the UE 102 can detect a beam failure.

The events 305A, 308A, and 310A are collectively referred to in this disclosure as a beam failure timer initiation procedure 312A. While the timer is running, if the UE 102 detects 316A a beam failure, then the UE 102 performs 318A a beam failure recovery procedure. Different beam failure recovery procedures that the UE 102 can perform are discussed with reference to FIGS. 4A-4E. If the UE 102 does not detect a beam failure while the timer is running, and instead detects 320A that the timer has expired, then the UE 102 stops 322A monitoring for beam failure. In some implementations, the base station 104 transmits 324A a command to the UE 102 to stop the timer. For example, the command can be included in an RRC message (e.g., an RRC Release message), a MAC CE, or a physical signal (e.g., a hybrid automatic repeat request (HARM) acknowledgment). In response to the command, the UE 102 stops 326A the timer and, correspondingly, stops 328A monitoring for beam failure. The base station 104 may determine that the UE 102 should stop the timer (and stop performing beam failure detection) in order to save power.

The events 316A, 318A, 324A, 326A, 328A, 320A, and 322A are collectively referred to in this disclosure as a beam failure detection procedure 330A.

Turning to FIG. 3B, a UE 102 communicates with a base station 104 during a scenario 300B. The scenario 300B is generally similar to the scenario 300A, except that the trigger event for starting the beam failure timer includes receiving downlink data rather than transmitting uplink data. Initially, the base station 104 transmits 302B a configuration message including one or more configurations, similar to the configuration message that the base station 104 transmits 302A. In the scenario 300B, the configuration message includes at least one or more configured downlink assignments. A downlink assignment includes a radio resource configuration for a scheduled downlink transmission (e.g., time and/or frequency resources, a modulation and coding scheme (MCS), etc.). While operating in the inactive state, the UE 102 can receive downlink data in accordance with a downlink assignment at a pre-defined time occasion.

The configuration message that the base station 104 transmits 302B may be an RRC message that causes the UE 102 to transition to an inactive state (e.g., RRC_INACTIVE), such as an RRC Release message or an RRC Reject message.

Accordingly, after or in response to the configuration message, the UE 102 begins 304B to operate in an inactive state. The events 302B and 304B are collectively referred to in this disclosure as an inactive state initiation procedure 390B. Similar to the inactive state initiation procedure 390A, the UE 102 receives 302B configuration information for the UE 102 to utilize while operating in the inactive state, and the UE 102 enters 304B the inactive state. Thus, the UE 102 enters the inactive state configured to perform beam failure recovery (e.g., using the configuration information that the UE 102 receives 302B).

Next, the UE 102 receives 306B downlink data from the base station 104 in accordance with a downlink assignment included in the configuration message. Receiving the downlink data corresponds to a trigger event for starting a timer in which to perform beam failure detection. Thus, upon or after receiving the downlink data, the UE 102 starts 308B a timer (i.e., the beam failure timer the UE 102 starts 308A). During the time window while the timer is running, and only while the timer is running, the UE 102 monitors 310B for beam failure of a beam for communicating data with the base station 104. If the UE 102 receives downlink data in accordance with a second downlink assignment while the timer is running, the UE 102 can restart the timer, and continue to monitor for beam failure while the timer is running.

The events 306B, 308B, and 310B are collectively referred to in this disclosure as a beam failure timer initiation procedure 312B. After initiating the timer, the UE 102, with the base station 104 in some scenarios, performs 330B a beam failure detection procedure, similar to the beam failure detection procedure 330A. Thus, the UE 102 may detect a beam failure while the timer is running, the timer may expire and the UE 102 may stop performing beam failure detection, or the base station 104 may instruct the UE 102 to stop the timer.

Turning to FIG. 3C, a UE 102 communicates with a base station 104 during a scenario 300C. The scenario 300C is generally similar to the scenarios 300B and 300C, but the trigger event for starting the beam failure timer includes receiving a DCI. Initially, the base station 104 transmits 302C a configuration message including one or more configurations, similar to the configuration message that the base station transmits 302A.

In the scenario 300C, the configuration message includes a first radio network temporary identifier (RNTI). This first RNTI is an RNTI that the UE 102 utilizes when operating in the inactive state in order to detect and/or receive information transmitted from the base station 104 to the UE 102 while the UE 102 is operating in the inactive state. Further, the first RNTI may associated with the particular cell serving the UE 102 (e.g., the cell 124). While in the scenario 300C, the base station 104 transmits 302C the first RNTI to the UE 102, in other implementations, the UE 102 can utilize an RNTI previously configured at the UE 102 as the first RNTI. For example, the UE 102 can utilize a cell-RNTI (C-RNTI) that the UE 102 previously used while in a connected state as the first RNTI when the UE 102 transitions to the inactive state.

The configuration message that the base station 104 transmits 302C may be an RRC message that causes the UE 102 to transition to an inactive state (e.g., RRC_INACTIVE), such as an RRC Release message or an RRC Reject message.

Accordingly, after or in response to the configuration message, the UE 102 begins 304C to operate in an inactive state. The events 302C and 304C are collectively referred to in this disclosure as an inactive state initiation procedure 390C. Similar to the inactive state initiation procedure 390A, the UE 102 receives 302C configuration information for the UE 102 to utilize while operating in the inactive state, and the UE 102 enters 304C the inactive state. Thus, the UE 102 enters the inactive state configured to perform beam failure recovery (e.g., using the configuration information that the UE 102 receives 302C).

Next, the UE 102 receives 307C a DCI. The base station 104 may transmit 307C the DCI on a Physical Downlink Control Channel (PDCCH). The DCI may indicate an uplink grant scheduling a data transmission from the UE 102 and/or a downlink assignment scheduling a data transmission to the UE 102. The UE 102 may receive 307C the DCI using the first RNTI that the UE 102 received 302C in the configuration message. The base station 104 can apply the first RNTI to the DCI before transmitting 307C the UE 102 by, for example, scrambling a cyclic redundancy check (CRC) attachment of the DCI and transmitting 307C the DCI and the CRC attachment to the UE 102). To receive the DCI, the UE 102 can descramble the CRC attachment using the first RNTI. Instead of or in addition to scheduling downlink and/or uplink data transmissions, the DCI may include random access preambles for the UE 102 to utilize when operating in the inactive state, which will be discussed with reference to FIGS. 4A-4D. Further, the base station 104 may transmit 307C the DCI to the UE 102 at a paging occasion for the UE 102, which will be discussed with reference to FIG. 7.

Receiving the DCI corresponds to a trigger event for starting a timer in which to perform beam failure detection. Thus, upon or after receiving 307C, the UE 102 starts 308C a timer (i.e., the beam failure timer the UE 102 starts 308A). During the time window while the timer is running, and only while the timer is running, the UE 102 monitors 310C for beam failure of a beam for communicating data with the base station 104. If the UE 102 receives a second DCI while the timer is running, the UE 102 can restart the timer, and continue to monitor for beam failure while the timer is running.

In addition to, or instead of, starting the timer in response to receiving 307C the DCI, the UE 102 can start (or restart) the timer if the UE 102 receives data in accordance with a downlink assignment scheduled by the DCI or transmits data in accordance with an uplink grant scheduled by the DCI.

The events 307C, 308B, and 310C are collectively referred to in this disclosure as a beam failure timer initiation procedure 312C. After initiating the timer, the UE 102, with the base station 104 in some scenarios, performs 330C a beam failure detection procedure, similar to the beam failure detection procedure 330A. Thus, the UE 102 may detect a beam failure while the timer is running, the timer may expire and the UE 102 may stop performing beam failure detection, or the base station 104 may instruct the UE 102 to stop the timer.

Turning to FIG. 3D, a UE 102 communicates with a base station 104 during a scenario 300D. The scenario 300D is generally similar to the scenario 300B, except that the trigger event for starting the beam failure timer includes receiving downlink data containing a UE Contention Resolution Identity MAC CE. Initially, the base station 104 transmits 302D a configuration message including one or more configurations, similar to the configuration message that the base station 104 transmits 302A. In the scenario 300D, the configuration message includes random access resources such as at least one or more random access preambles and/or time/frequency resources. After or in response to the configuration message, the UE 102 begins 304D to operate in an inactive state. The events 302D and 304D are collectively referred to in this disclosure as an inactive state initiation procedure 390D.

While operating in the inactive state, if the UE 102 initiates 305D a random access procedure, the UE 102 can receive 306D downlink data containing a UE Contention Resolution Identity MAC CE as part of the random access procedure. For example, the UE 102 can initiate 305D the random access procedure by transmitting a random access preamble to the base station 104 (e.g., in a Msg1 of a four-step contention-based random access procedure or a MsgA of a two-step contention-based random access procedure). During the random access procedure, the UE 102 also transmits a common control channel (CCCH) SDU to the base station 104 (e.g., in a Msg3 of a four-step contention-based random access procedure or the MsgA of a two-step contention-based random access procedure). The UE 102 can receive 306D the UE Contention Resolution Identity MAC CE in a Msg4 or a MsgB of a four-step or a two-step contention-based random access procedure, respectively. Four-step and two-step contention-based random access procedures are discussed in further detail below with reference to FIGS. 4C and 4D, respectively. If the UE 102 successfully receives the UE Contention Resolution Identity MAC CE (i.e., the UE Contention Resolution Identity included in the MAC CE matches the CCCH SDU), then the UE 102 can determine that the random access procedure is successfully completed, and can start 308D the timer. Thus, the trigger event can be described (i) as successfully completing a random access procedure while in the inactive state or (ii) as receiving downlink data including a UE Contention Resolution Identity MAC CE as part of a random access procedure while in the inactive state. During the time window while the timer is running, and only while the timer is running, the UE 102 monitors 310D for beam failure of a beam for communicating data with the base station 104.

The events 305D, 306D, 308D, and 310D are collectively referred to in this disclosure as a beam failure timer initiation procedure 312D. After initiating the timer, the UE 102, with the base station 104 in some scenarios, performs 330D a beam failure detection procedure, similar to the beam failure detection procedure 330A.

FIGS. 3A-3D illustrate different trigger events that, if detected by the UE 102, the UE 102 starts a beam failure timer and monitors for beam failure while the beam failure timer is running. It should be noted that the UE 102 can combine the techniques illustrated in FIGS. 3A-3D. For instance, the UE 102 can start or restart the beam failure timer in response to transmitting data in accordance with a configured grant, receiving data in accordance with a downlink assignment, receiving a DCI, and/or receiving downlink data as part of a random access procedure.

Turning to FIGS. 4A-4E, a UE 102 can perform a variety of different beam failure recovery procedures in response to detecting a beam failure when operating in the inactive mode.

FIG. 4A illustrates a scenario 400A in which a UE 102 communicates with a base station 104. Initially, the UE 102 enters 490A an inactive state with beam failure recovery. As illustrated by FIGS. 3A-3D, the UE 102 may receive a configuration message and enter the inactive state configured to perform beam failure recovery. The UE 102 then performs 412A a beam failure initiation procedure, which may be any one of the beam failure initiation procedures 312A, 312B, 312C, or 312D. While the beam failure timer is running, the UE 102 detects 416A a beam failure of a beam for communicating data with the base station 104.

In response to detecting 416A the beam failure, the UE 102 may select a new beam on which to perform beam failure recovery. The UE 102 can select the new beam based on signal measurements performed by the UE 102 on the new beam. The signal measurements may be measurements that the UE 102 performed while the timer was running, prior to detecting the beam failure, or may be measurements that the UE 102 performs in response to detecting the beam failure. The UE 102 can select a beam that has a signal strength and/or signal quality above a signal strength threshold and/or signal quality threshold, respectively (e.g., the thresholds utilized for to detect 416A beam failure, or another suitable threshold). If more than one beam has a signal strength and/or signal quality above a respective threshold, then the UE 102 can select the beam with the highest signal strength and/or signal quality. If no beam has a signal strength and/or signal quality above the respective threshold, in some embodiments, the UE 102 performs cell reselection in order to select a different cell. The UE 102 can perform signal measurements on the new cell to perform beam failure recovery. In other embodiments, if no beam has a signal strength and/or signal quality above the respective threshold, the UE 102 can initiate a random access procedure.

After selecting 432A a new beam, the UE 102 can use a contention-free random access procedure in order to perform beam failure recovery. To perform the contention-free random access procedure, the UE 102 transmits 434A a dedicated random access preamble associated with the selected beam. The UE 102 may receive the dedicated random access preamble in the configuration message that the UE 102 receives during event 490A (e.g., within a DCI). The term “dedicated” in this context refers to the random access preamble being dedicated to the UE 102 and/or to the random access preamble being dedicated for use to recover from a beam failure when operating in the inactive state. For example, the dedicated random access preamble may be a random access preamble that is (i) allocated to the specific UE 102, and (ii) allocated for UEs operating in an inactive state to use in beam failure recovery. If the dedicated random access preamble is dedicated for use in beam failure recovery, the base station 104 can determine, based on receiving the dedicated random access preamble, that the UE 102 is in an inactive state and performing beam failure recovery.

In response to receiving 434A the dedicated random access preamble, the base station 104 can complete the contention-free random access procedure by transmitting 436A a random access response (RAR) to the UE 102.

In some implementations, the base station 104 (e.g., in the configuration message the UE 102 receives during event 490A) may indicate a dedicated Physical Random Access Channel (PRACH) occasion on which to transmit a random access preamble or a dedicated random access preamble for an associated beam. The dedicated PRACH occasion may be dedicated to the UE 102 and/or dedicated to performing beam failure recovery while operating in the inactive state. If the PRACH occasion is dedicated to performing beam failure recovery, then the base station 104 can determine, based on the PRACH occasion, that the UE 102 is performing beam failure recovery and operating in the inactive state. In such implementations, the UE 102 transmits 434A a dedicated random access preamble or a random access preamble at the dedicated PRACH occasion associated with the selected beam.

The events 432A, 434A, and 436A are collectively referred to in this disclosure as a beam failure recovery procedure 418A.

Turning to FIG. 4B, a scenario 400B is generally similar to the scenario 400A. The events 490B, 412B, 416B, 432B, and 434B may be similar to the events 490A, 412A, 416A, 432A, and 434A, respectively. After receiving 434B the dedicated random access preamble associated with the selected beam, the base station 104 applies a first RNTI to a DCI for the UE 102 and transmits the DCI to the UE 102. For example, the base station 104 may encode the DCI using the first RNTI (e.g., by scrambling a CRC attachment of the DCI with the first RNTI). As discussed previously, the UE 102 may receive the first RNTI during the event 490B, or may re-use a C-RNTI as the first RNTI. In response to receiving 436B the DCI using the first RNTI, the UE 102 can determine that the random access procedure, and the beam failure recovery procedure, is complete. The base station 104 may include the DCI in a random access response, or another suitable message. The DCI may indicate an uplink grant and/or a downlink assignment for the UE 102 to communicate data with the base station 104. The events 432B, 434B, and 436B are collectively referred to in this disclosure as a beam failure recovery procedure 418B.

Turning to FIG. 4C, a scenario 400C is generally similar to the scenario 400A, except that the UE 102 uses a four-step contention-based random access procedure to perform beam failure recovery. The events 490C, 412C, 416C, and 432C are generally similar to the events 490A, 412A, 416A, and 432A, respectively. The UE 102 initiates a four-step contention-based random access procedure by transmitting 434C a random access preamble associated with the selected beam to the base station 104. In some embodiments, the random access preamble is associated with the selected beam. Additionally or alternatively, the UE 102 may transmit a random access preamble to the base station 104 via a PRACH occasion associated with the selected beam. The base station 104 can indicate random access preambles and/or PRACH occasions associated with beams to the UE 102 during the event 490C.

In response to receiving 434C the random access preamble, the base station 104 transmits 436C a random access response to the UE 102. The UE 102 then transmits 438C a scheduled transmission including a payload to the base station 104, and the base station 104 transmits 440C a contention resolution to the UE 102. The events 434C, 436C, 438C, and 440C may be, respectively, “Msg1,” “Msg2,” “Msg3,” and “Msg4” of the four-step random access procedure. The payload transmission that the UE 102 transmits 438C may include an indication that the UE 102 initiated the random access procedure in response to detecting a beam failure and/or in order to recover a beam failure. The indication may be a field, an information element (IE), a MAC CE, or a physical signal. Additionally or alternatively, the payload transmission that the UE 102 transmits 438C includes an indication of a candidate beam with a signal measurement above a threshold. The signal measurement may be performed by the UE 102 during a time window while the timer was running or in response to detecting the beam failure.

The events 432C, 434C, 436C, 438C, and 440C are collectively referred to in this disclosure as a beam failure recovery procedure 418C.

Turning to FIG. 4D, a scenario 400D is generally similar to the scenario 400C, except that the UE 102 uses a two-step contention-based random access procedure rather than a four-step contention-based random access procedure to perform the beam failure recovery. Thus, the events 490D, 412D, 416D, and 432D are similar to the events 490C, 412C, 416C, and 432C, respectively. The UE 102 initiates a two-step contention-based random access procedure by transmitting 435C a random access preamble and transmitting 437C a payload transmission to the base station 104. The events 435D and 437D may collectively be referred to as a “MsgA” of the two-step random access procedure. The random access preamble and the payload transmission are two parts of the MsgA that are sent at different occasions: the UE 102 transmits the random access preamble via a PRACH occasion (e.g., similar to Msg1 of the four-step random access procedure), and the UE 102 transmits the payload transmission via a PUSCH occasion (e.g., similar to Msg3 of the four-step random access procedure). The payload transmission that the UE 102 transmits 437D, like the payload transmission the UE 102 transmits 438C, can include an indication that the UE 102 initiated the random access procedure in response to detecting a beam failure and/or to recover a beam failure. Likewise, the payload transmission may include an indication of a candidate beam.

In response to the MsgA, the base station 104 transmits 440D a contention resolution to the UE 102. The event 440D may be a “MsgB” of the two-step random access procedure. The events 432D, 435D, 437D, and 440D are collectively referred to in this disclosure as a beam failure recovery procedure 418D.

Turning to FIG. 4E, a scenario 400E is similar to the scenarios 400A-400D, except that the UE 102 uses a CG to perform beam failure recovery rather than a random access procedure. The events 490E, 412E, 416E, and 432E are similar to the events 490A, 412A, 416A, and 432A, respectively. During the event 490E, the base station 104 indicates one or more CGs associated with one or more respective beams. After the UE 102 selects 432E a beam, the UE 102 transmits 442E a message to the base station 104 using a CG associated with the selected beam. The message, similar to the payload transmission the UE 102 transmits 438C or 437D, can include an indication that the UE 102 transmitted the message in response to detecting a beam failure and/or to recover a beam failure. Likewise, the message may include an indication of a candidate beam. The events 432E and 442E are collectively referred to in this disclosure as a beam failure recovery procedure 418E.

If the UE 102 receives 446E a transmission from the base station 104 on the selected beam, then the UE 102 can start the beam failure timer (or restart the beam failure timer is the beam failure timer is already running).

In any of the scenarios 300A-D and 400A-E, the UE 102 may release the first RNTI (in scenarios in which the UE 102 utilizes the first RNTI) and/or CGs if certain conditions are met. In some implementations, the UE 102 releases the first RNTI and/or CGs in response to a timing alignment timer (TAT) expiring. In other embodiments, if the UE 102 successfully completes a random access procedure (e.g., a RA-based SDT) with the base station 104, the base station 104 may assign a C-RNTI to the UE 102. The UE 102 can release the first RNTI and/or the CGs in response to being assigned the C-RNTI. Alternatively, the UE 102 can retain the first RNTI and utilize the first RNTI as a C-RNTI in a connected state after completing the random access procedure. In yet other embodiments, if the UE 102 successfully completes a random access procedure, the UE 102 may retain the first RNTI and/or the CGs, and may utilize the first RNTI as a configured scheduling-RNTI (CS-RNTI). In further embodiments, the UE 102 can release the first RNTI and/or the CGs in response to a message from the base station 104 that causes the UE 102 (i) to enter a connected state (e.g., an RRCResume message or an RRCSetup message), or (ii) to enter an idle state (e.g., an RRCRelease message or an RRCReject message).

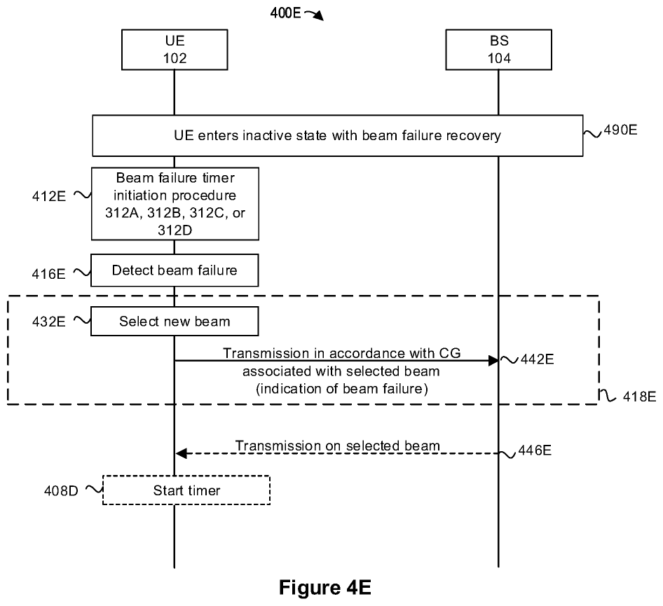

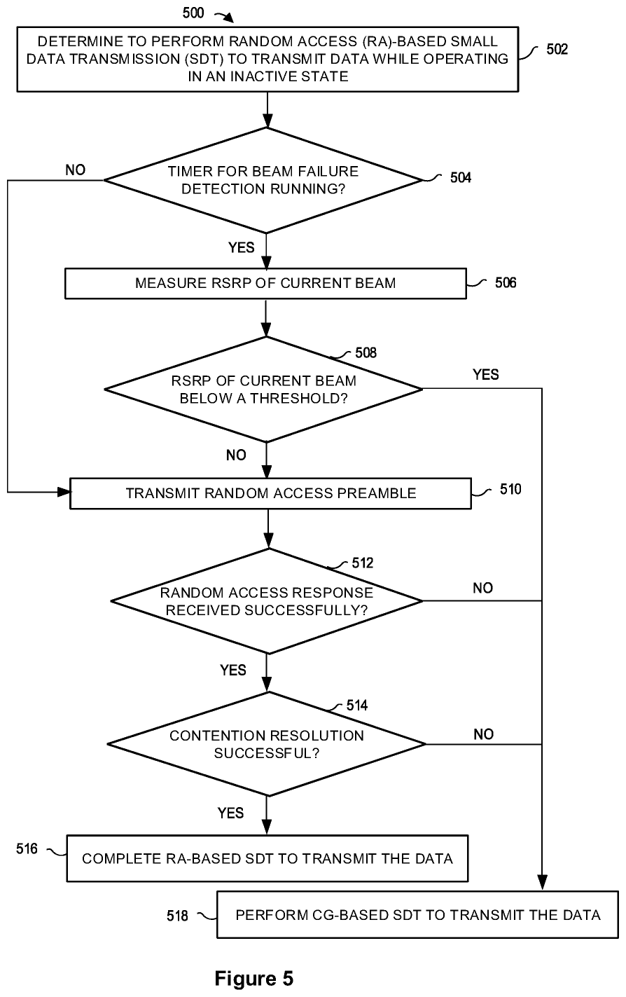

FIGS. 5-10 are flow diagrams of example methods that a base station and/or a UE can implement the beam management and communication techniques of this disclosure.

Turning to FIG. 5, an example method 500 for transmitting data when operating in an inactive mode can be implemented in a UE (e.g., the UE 102). At block 502, the UE determines to perform RA-based SDT to transmit data to a base station (e.g., the base station 104) while operating in an inactive state. The UE may, or may not, be transmitting the data in order to perform beam failure recovery. At block 504, the UE determines whether a timer for beam failure detection is running (e.g., the beam failure timer that the UE 102 starts at events 308A-D or similar events within procedures 412A-E). If the timer is not running, then the flow generally proceeds to block 510. In some scenarios, however, if the timer is not running, but the UE previously performed signal measurements for the current beam, then the flow can proceed directly from block 504 to block 508.

If the timer is running, then the flow proceeds to block 506. At block 506, the UE measures an RSRP (i.e., a signal strength) of the current beam serving the UE. In some implementations, the UE may measure a signal quality in addition to or instead of the RSRP. Next, at block 508, the UE determines whether the RSRP of the current beam is below a threshold. The threshold may be the same signal strength threshold that the UE utilizes to monitor for a beam failure (e.g., at events 310A-D or similar events within procedures 412A-E), or may be a different threshold that is pre-stored at the UE or configured at the UE by a base station. If the UE is utilizing the RA-based SDT to perform beam failure recovery, then the UE may already have performed signal measurements when performing beam failure detection. Thus, in some implementations, the UE can compare previously-performed signal measurements to the threshold and skip directly from block 504 to block 508 without performing new signal measurements.

If the RSRP is below the threshold, then the flow proceeds to block 518. If the RSRP is not below the threshold, then the flow proceeds to block 510. At block 510, the UE initiates a random access procedure by transmitting a random access preamble, which may be a dedicated random access preamble, to the base station. Next, at block 512, the UE determines whether the UE successfully received a random access response from the base station in response to the random access preamble. The UE can determine that the UE successfully received the random access response if the UE received a random access response, including a preamble identifier of the preamble that the UE transmitted at block 510, prior to the end of a random access response time window.

If the UE does not successfully receive the random access response, the flow proceeds to block 518. If the UE successfully received the random access response, then the UE determines, at block 514, whether the UE successfully received a contention resolution from the base station. The UE can determine that the UE successfully received the contention resolution if the UE received a transmission from the base station including a MAC CE for the UE before a contention resolution timer expires (e.g., an ra-ContentionResolutionTimer). If the random access procedure is two-step contention based random access procedure, the method can skip block 512 and proceed directly from block 510 to block 514.

If the UE successfully received the contention resolution, then at block 516, the RA-based SDT is completed. The UE can transmit the data after transmitting the random access preamble (e.g., in a Msg3 of a four-step contention-based random access procedure or in the payload transmission of a MsgA of a two-step contention-based random access procedure), such that the RA-based SDT completes when the UE receives the contention resolution. If the UE does not successfully receive the contention resolution, then the flow proceeds to block 518

At block 518, the UE determines to switch from the RA-based SDT to a CG-based SDT in order to transmit the data. The UE can select a CG and use transmit the data to the base station in accordance with the CG. The UE can select a CG associated with a beam based on signal measurements. The UE can utilize signal measurements performed during a previous time window if the timer is not running, or can perform signal measurements if the timer is running. If the UE is using the SDT to perform beam failure recovery, the UE may perform signal measurements in response to detecting a beam failure, and can use these signal measurements to select a CG.

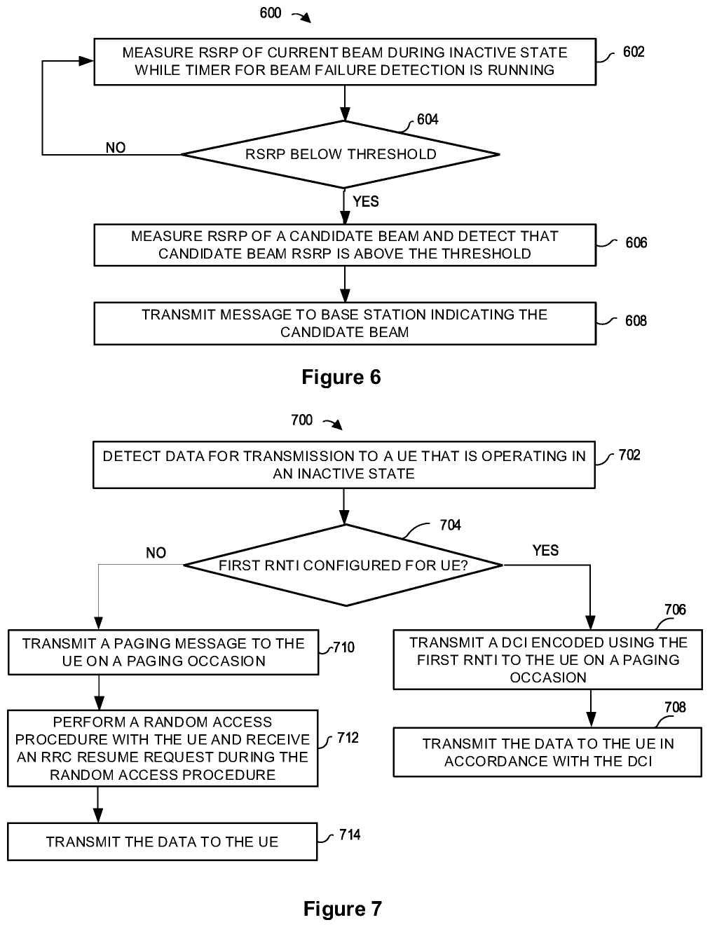

Turning to FIG. 6, a method 600 for transmitting an indication of a candidate beam to a base station (e.g., the base station 104) can be implemented in a UE (e.g., the UE 102). At block 602, the UE, operating in an inactive state, measures an RSRP of a current beam while a timer for beam failure detection is running (e.g., the beam failure timer that the UE 102 starts at events 308A-D or similar events within procedures 412A-E). In some implementations, the UE may measure a signal quality in addition to or instead of the RSRP. At block 604, the UE determines whether the RSRP is below a threshold (e.g., the threshold that the UE 102 utilizes to monitor for beam failure at events 310A-D or similar events within procedures 412A-E). If the RSRP is not below the threshold, then the flow may return to block 602 and the UE can continue to perform signal measurements while the timer is running. If the UE detects a trigger event for the timer (e.g., the UE transmits data in accordance with a CG, as in event 305A, the UE receives data in accordance with a configured downlink assignment, as in event 306B, the UE receives a DCI, as in event 307C, or the UE receives a UE Contention Resolution Identity MAC CE, as in event 306D), then the UE can restart the timer and perform signal measurements while the timer is running. If the UE receives a stop timer command from the base station (e.g., event 324A), then the UE can stop the timer and stop performing signal measurements.

If the RSRP is below the threshold, then the flow proceeds to block 606, where the UE can measure the RSRP of a candidate beam and detect that the candidate beam RSRP is above the threshold. The UE may detect a beam failure of the current beam in response to detecting that the RSRP for the current beam is below the threshold, and may measure the RSRP of the candidate beam when selecting a new beam to recover from the beam failure (e.g., events 432A-E). At block 608, the UE transmits a message to the base station, the message including an indication of the candidate beam. In some implementations, the message is included in a Msg3 of a four-step contention-based random access procedure, in a payload transmission of a MsgA of a two-step contention-based random access procedure, or in a transmission in accordance with a CG (e.g., event 438C, 437D, or 442E). The indication may be included in a MAC CE, RRC message, or a physical signal such as a channel state information (CSI). For example, the UE can indicate the candidate beam using a logical channel group identifier (LCG ID) in a MAC CE. At a later time, the UE may receive a command from the base station to switch to the candidate beam to communicate with the base station.

Turning to FIG. 7, a method 700 for transmitting data to a UE (e.g., the UE 102) operating in an inactive state can be implemented in a base station (e.g., the base station 104). The method 700 can be implemented in a RAT of any suitable type, including Long Term Evolution (LTE), 5G NR, and 6G. At block 702, the base station detects data for transmission to a UE that is operating in an inactive state. For example, the base station can determine that the UE is in the inactive state because the base station previously transmitted an RRC message (e.g., an RRCRelease or an RRCReject message) to the UE that caused the UE to transition to the inactive state. Next, at block 704, the base station determines whether the UE has been configured with a first RNTI. For example, the base station may previously have transmitted a first RNTI to the UE (e.g., event 302C). The first RNTI allows the base station to directly address data and/or control information to the UE while the UE is operating in the inactive mode.

If the UE has been configured with a first RNTI, then the flow proceeds to block 706. At a paging occasion for the UE, the base station transmits a DCI encoded using the first RNTI (e.g., a DCI and a CRC attachment scrambled using the first RNTI) to the UE. The DCI includes time and/or frequency resources that the UE can use to receive the data. To transmit the DCI at the paging occasion, the base station may include the DCI in a paging message encoded using a paging-RNTI (P-RNTI). Accordingly, at the paging occasion, the UE can use the P-RNTI to detect the paging message, and can use the first RNTI to decode the DCI. Before using the first RNTI, the UE may use an inactive I-RNTI to determine whether there is a paging record containing the I-RNTI in the paging message. If the paging record does not contain the I-RNTI, then UE can detect and decode the DCI using the first RNTI. At block 708, the base station can then transmit the data to the UE in accordance with the DCI. By using the first RNTI to directly address a DCI to the UE, the base station can schedule and transmit data to the UE operating in the inactive mode without performing a random access procedure.

If the UE has not been configured with a first RNTI, then the flow proceeds to block 710. At a paging occasion for the UE, the base station transmits a paging message to the UE encoded with a P-RNTI. The paging message includes a paging record containing an I-RNTI (e.g., a fullI-RNTI). At block 712, the base station performs a random access procedure with the UE. During the random access procedure, the base station receives an RRC resume request message (e.g., an RRCResume message) from the UE. The RRC resume request message may include a second I-RNTI (e.g., a shortI-RNTI). At block 714, during the random access procedure (e.g., within the random access response) or after the random access procedure is completed, the base station transmits the data to the UE.

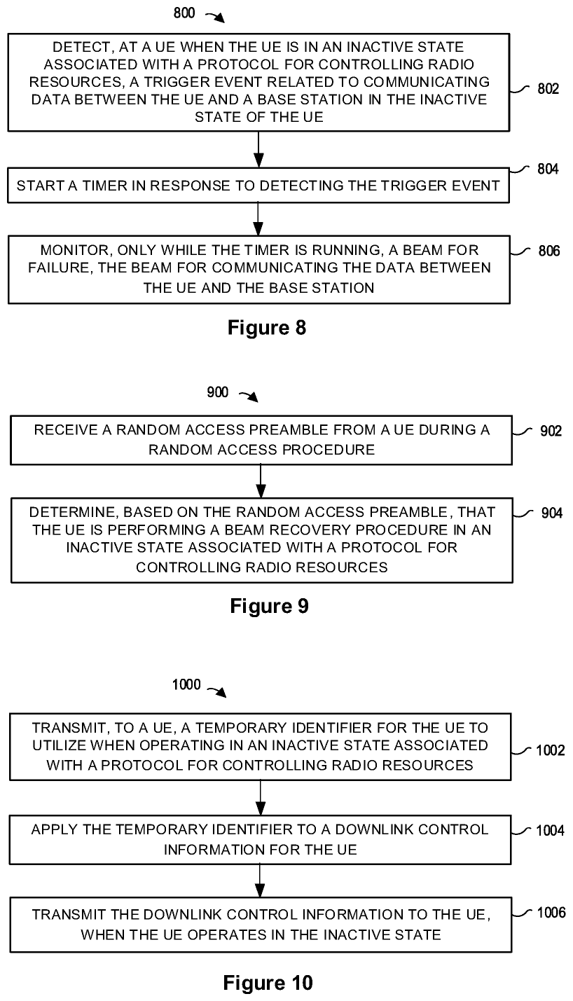

Turning to FIG. 8, a method 800 for beam management can be implemented in a UE (e.g., the UE 102). At block 802, the UE detects, when the UE is in an inactive state associated with a protocol for controlling radio resources (e.g., RRC_INACTIVE), a trigger event related to communicating data between the UE and a base station (e.g., the base station 104) in the inactive state of the UE (e.g., event 305A, 306B, 307C, 306D, or similar events during procedures 412A-E). In response to detecting the trigger event, the UE starts a timer at block 804 (e.g., events 308A-D or similar events during procedures 412A-E). At block 806, the UE monitors, only while the timer is running, a beam for failure, the beam for communicating the data between the UE and the base station (e.g., events 310A-D, or similar events during procedures 412A-E).

Turning to FIG. 9, a method 900 for beam management can be implemented in a base station (e.g., the base station 104). At block 902, the base station receives a random access preamble from a UE (e.g., the UE 102) during a random access procedure (e.g., event 434A, 434B). At block 904, the base station determines, based on the random access preamble, that the UE is performing a beam recovery procedure in an inactive state associated with a protocol for controlling radio resources (e.g., RRC_INACTIVE). The random access preamble may be a “dedicated” random access preamble allocated for performing beam failure recovery. Further, the random access preamble may also be dedicated to the specific UE.

Turning to FIG. 10, a method 1000 for communicating with a UE (e.g., the UE 102) can be implemented in a base station (e.g., the base station 104). At block 1002, the base station transmits, to a UE, a temporary identifier (e.g., the first RNTI) for the UE to utilize when operating in an inactive state associated with a protocol for controlling radio resources (e.g., RRC_INACTIVE) (e.g., event 302C or similar events within procedures 490A-E). At block 1004, the base station applies the temporary identifier to a downlink control information (e.g., a DCI) for the UE (e.g., by scrambling a CRC attachment for the DCI using the temporary identifier). At block 1006, the base station transmits the downlink control information to the UE, when the UE operates in the inactive state (e.g., event 307C or similar events within the procedures 412A-E). The DCI, for example, may include dedicated random access preamble(s) for the UE to utilize to perform a contention-free random access procedure and/or to perform beam failure recovery.

The following list of examples reflects a variety of the embodiments explicitly contemplated by the present disclosure:

Example 1. A beam management method in a user equipment (UE), the method comprising: detecting, by processing hardware and when the UE is in an inactive state associated with a protocol for controlling radio resources, a trigger event related to communicating data between the UE and a base station in the inactive state of the UE; starting, by the processing hardware, a timer in response to detecting the trigger event; monitoring, by the processing hardware and only while the timer is running, a beam for failure, the beam for communicating the data between the UE and the base station.

Example 2. The method of example 1, wherein the trigger event includes communicating with the base station in accordance with a scheduled communication.

Example 3. The method of example 2, wherein the communicating includes transmitting uplink data to the base station in accordance with a configured grant received at the UE from the base station.

Example 4. The method of example 2, wherein the communicating includes receiving downlink data from the base station in accordance with a configured downlink assignment received at the UE from the base station.

Example 5. The method of any one of examples 2-4, wherein the scheduled communication is a first scheduled communication, the method further comprising: restarting, by the processing hardware, the timer in response to communicating with the base station in accordance with a second scheduled communication.

Example 6. The method of any one of examples 1-5, wherein the trigger event includes receiving, from the base station, a downlink control information that schedules communicating the data.

Example 7. The method of example 1, wherein the trigger event includes receiving downlink data during a random access procedure with the base station.

Example 8. The method of example 7, wherein the downlink data includes a medium access control (MAC) layer control element including a UE contention resolution identity.

Example 9. The method of any one of examples 1-8, further comprising: detecting, by the processing hardware, the beam failure based on the monitoring.

Example 10. The method of example 9, wherein detecting the beam failure includes determining that a signal strength of the beam is below a signal strength threshold.

Example 11. The method of example 10, wherein detecting the beam failure further includes determining that the signal strength of the beam stays below the signal strength threshold for a predetermined time.

Example 12. The method of example 9, wherein detecting the beam failure includes determining that a number of beam failure instances, detected at a layer below a medium access control (MAC) layer, exceeds a predetermined number.

Example 13. The method of any one of examples 9-12, further comprising: in response to detecting the beam failure, performing, by the processing hardware, a beam failure recovery procedure.

Example 14. The method of example 13, wherein: the beam is a first beam; and performing the beam failure recovery procedure includes: selecting, by the processing hardware, a second beam based on a signal strength measurement of the second beam.

Example 15. The method of example 14, wherein performing the beam failure recovery procedure includes: performing a random access procedure with the base station, including transmitting, to the base station, a dedicated random access preamble associated with the second beam and with the failure recovery procedure in the inactive state of the UE.

Example 16. The method of example 14, wherein performing the beam failure recovery procedure includes: performing, by the processing hardware, a random access procedure with the base station, including transmitting (i) a preamble associated with the second beam and (ii) a payload to the base station.

Example 17. The method of example 14, further comprising: receiving, by the processing hardware from the base station prior to detecting the beam failure, a second configured grant associated with the second beam; wherein performing the beam failure recovery procedure includes: transmitting a payload to the base station in accordance with the second configured grant.

Example 18. The method of example 16 or 17, wherein the payload includes an indication that the UE detected the beam failure.

Example 19. The method of any one of examples 16-18, further comprising: performing, by the processing hardware, a signal strength measurement of a candidate beam, wherein the payload includes an indication of the candidate beam if the signal strength measurement of the candidate beam exceeds a predetermined threshold.

Example 20. The method of any one of examples 1-19, further comprising: receiving, by the processing hardware from the base station, a temporary identifier for the UE to utilize when the UE is operating in the inactive state.

Example 21. The method of any example 20, further comprising: receiving, by the processing hardware, a downlink control information including an attachment scrambled using the temporary identifier.

Example 22. The method of example 20 or 21, further comprising: releasing, by the processing hardware, the temporary identifier in response to transitioning to a connected state associated with the protocol for controlling radio resources.

Example 23. The method of example 20 or 21, further comprising: retaining, by the processing hardware, the temporary identifier after transitioning to a connected state associated with the protocol for controlling radio resources; and using, by the processing hardware, the temporary identifier while operating in the connected state.

Example 24. The method of any one of the preceding examples, further comprising: detecting, by the processing hardware, that the timer has stopped or has expired; and in response to detecting that the timer has stopped or has expired, stopping to monitor for the beam failure.

Example 25. The method of example 24, further comprising: stopping, by the processing hardware, the timer in response to receiving a command from the base station.

Example 26. A user equipment (UE) including processing hardware and configured to implement a method according to any one of the preceding examples.

Example 27. A beam management method in a base station, the method comprising: receiving, by processing hardware from a UE, a random access preamble during a random access procedure; determining, by the processing hardware, based on the random access preamble, that the UE is performing a beam recovery procedure in an inactive state associated with a protocol for controlling radio resources.

Example 28. The method of example 27, further comprising: transmitting, by the processing hardware, a downlink control information to the UE prior to the random access procedure, the downlink control information including an attachment scrambled using a temporary identifier allocated to the UE to utilize when operating in the inactive state.

Example 29. A method in a base station for communicating with a user equipment (UE), the method including: transmitting, by a processing hardware of the base station to the UE, a temporary identifier for the UE to utilize when operating in an inactive state associated with a protocol for controlling radio resources; applying, by the processing hardware, the temporary identifier to a downlink control information for the UE; transmitting, by the processing hardware, the downlink control information to the UE, when the UE operates in the inactive state.

Example 30. The method of example 29, wherein transmitting the downlink control information includes transmitting the downlink control information at a paging occasion for the UE.

Example 31. The method of example 29 or 30, wherein transmitting the downlink control information includes transmitting the downlink control information including a dedicated random access preamble allocated to the UE to perform a random access procedure while operating in the inactive state.

Example 32. A base station including processing hardware and configured to implement a method according to any one of examples 27-31.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for beam management and SDT through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A beam management method implemented in a user equipment (UE), the method comprising:
detecting, when the UE is in an inactive state associated with a protocol for controlling radio resources, a trigger event related to communicating data between the UE and a base station in the inactive state of the UE;
starting a timer in response to detecting the trigger event; and
monitoring, only while the timer is running, a current beam for failure, the current beam for communicating the data between the UE and the base station.

2. The method of claim 1, wherein the trigger event includes transmitting uplink data to the base station in accordance with a configured grant received at the UE from the base station.

3. The method of claim 1, wherein the trigger event includes receiving downlink data from the base station in accordance with a configured downlink assignment received at the UE from the base station.

4. The method of claim 1, wherein the trigger event includes receiving, from the base station, a downlink control information that schedules communicating the data.

5. The method of claim 1, wherein the trigger event includes receiving downlink data during a random access procedure with the base station.

6. The method of claim 1, wherein the current beam is a first beam, the method further comprising:
detecting the beam failure based on the monitoring; and
in response to detecting the beam failure, performing a beam failure recovery procedure, wherein the performing includes selecting a second beam based on a signal strength measurement of the second beam.

7. The method of claim 6, wherein performing the beam failure recovery procedure includes:
performing a random access procedure with the base station, including transmitting, to the base station, a dedicated random access preamble associated with the second beam and with the failure recovery procedure in the inactive state of the UE.

8. The method of claim 6, wherein performing the beam failure recovery procedure includes:
performing a random access procedure with the base station, including transmitting (i) a preamble associated with the second beam and (ii) a payload to the base station.

9. The method of claim 6, further comprising:
receiving, from the base station prior to detecting the beam failure, a second configured grant associated with the second beam;
wherein performing the beam failure recovery procedure includes:
transmitting a payload to the base station in accordance with the second configured grant.

10. The method of claim 8, wherein the payload includes an indication that the UE detected the beam failure.

11. The method of claim 1, further comprising:
performing a signal strength measurement of a candidate beam, wherein the payload includes an indication of the candidate beam if the signal strength measurement of the candidate beam exceeds a predetermined threshold.

12. The method of claim 1, further comprising:
receiving, from the base station, a temporary identifier for the UE to utilize when the UE is operating in the inactive state; and
releasing the temporary identifier in response to transitioning to a connected state associated with the protocol for controlling radio resources.

13. The method of claim 1, further comprising:
detecting that the timer has stopped or has expired; and in response to detecting that the timer has stopped or has expired, stopping the monitoring the current beam for failure.

14. The method of claim 13, further comprising:
stopping the timer in response to receiving a command from the base station.

15. A user equipment (UE) including processing hardware and configured to:
detect, when the UE is in an inactive state associated with a protocol for controlling radio resources, a trigger event related to communicating data between the UE and a base station in the inactive state of the UE,
start a timer in response to detecting the trigger event, and
monitor, only while the timer is running, a current beam for failure, the current beam for communicating the data between the UE and the base station.

16-18. (canceled)

17. The UE of claim 15, wherein the trigger event includes transmitting uplink data to the base station in accordance with a configured grant received at the UE from the base station.

18. The UE of claim 15, wherein the trigger event includes receiving downlink data from the base station in accordance with a configured downlink assignment received at the UE from the base station.

19. The UE of claim 15, wherein the trigger event includes receiving, from the base station, a downlink control information that schedules communicating the data.

20. The UE of claim 15, wherein the trigger event includes receiving downlink data during a random access procedure with the base station.

21. The UE of claim 15, further configured to:
receive, from the base station, a temporary identifier for the UE to utilize when the UE is operating in the inactive state; and
release the temporary identifier in response to transitioning to a connected state associated with the protocol for controlling radio resources.

22. The UE of claim 15, further configured to:
detect that the timer has stopped or has expired; and
in response to the detecting that the timer has stopped or has expired, stop the monitoring the current beam for failure.

23. The UE of claim 22, further configured to:
stop the timer in response to receiving a command from the base station.
